(19) United States
(12) Patent Application Publication
(10) Pub. No.: US 2014/0136289 A1
(43) Pub. Date: May 15, 2014

(54) AUTOMATED PRICES

(71) Applicant: Daniel E. Settgast, Miami, FL (US)

(72) Inventor: Daniel E. Settgast, Miami, FL (US)

(21) Appl. No.: 14/160,462

(22) Filed: Jan. 21, 2014

Related U.S. Application Data
(63) Continuation-in-part of application No. 13/955,993, filed on Jul. 31, 2013.
(60) Provisional application No. 61/677,929, filed on Jul. 31, 2012.

(51) Int. Cl. G06Q 30/02

(52) U.S. Cl. CPC G06Q 30/0206
USPC 705/7.35

(57) ABSTRACT

A method and system for tracking how well a product is selling and whether the price of a product should be raised or lowered. In an embodiment, a method for automating prices is provided by setting an initial pricing point for an item, and setting a time interval. The method also includes determining whether the item was purchased during the time interval, and determining whether the price of the item should be modified. The price is sent to a client machine as a sales price of the item.

### CROSS REFERENCE TO RELATED APPLICATIONS

This application is a continuation-in-part of U.S. patent application Ser. No. 13/955,993, entitled “Automated Prices,” by Daniel E. Settgast, filed Jul. 31, 2013 (docket #81-4), which claims priority benefit of U.S. Provisional Patent Application 61/677,929, by Daniel E. Settgast, filed Jul. 31, 2012 (docket #81-3), and the contents of all the above listed applications are incorporated herein by reference, in their entirety.

### FIELD

This specification generally relates to marketing products online.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Keeping up with how well a product is selling and whether the price of a product should be raised or lowered is time consuming, and at times requires continual monitoring of the sales of products.

### BRIEF DESCRIPTION OF THE FIGURES

In the following drawings, like reference numbers are used to refer to like elements. Although the following figures depict various examples of the invention, the invention is not limited to the examples depicted in the figures.

FIG. 1A shows a flowchart of an embodiment of a method of automatically setting prices for an item sold online.

FIG. 1B is a continuation of the flowchart in FIG. 1A.

FIG. 2A shows a flowchart of another embodiment of a method of automatically setting prices for an item sold online.

FIG. 2B is a continuation of the flowchart in FIG. 2A.

FIG. 2C is a continuation of the flowchart in FIG. 2B.

FIG. 3 is a flow diagram illustrating the client side process for purchasing an item using the automated pricing system.

FIG. 4 shows a representative system for automating prices.

FIG. 5 shows a bock diagram of an embodiment of a network in which the methods of FIGS. 1 and 2 may be implemented.

FIG. 6 shows a block diagram of a computer that may implement the method of FIGS. 1 and 2.

### DETAILED DESCRIPTION

Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

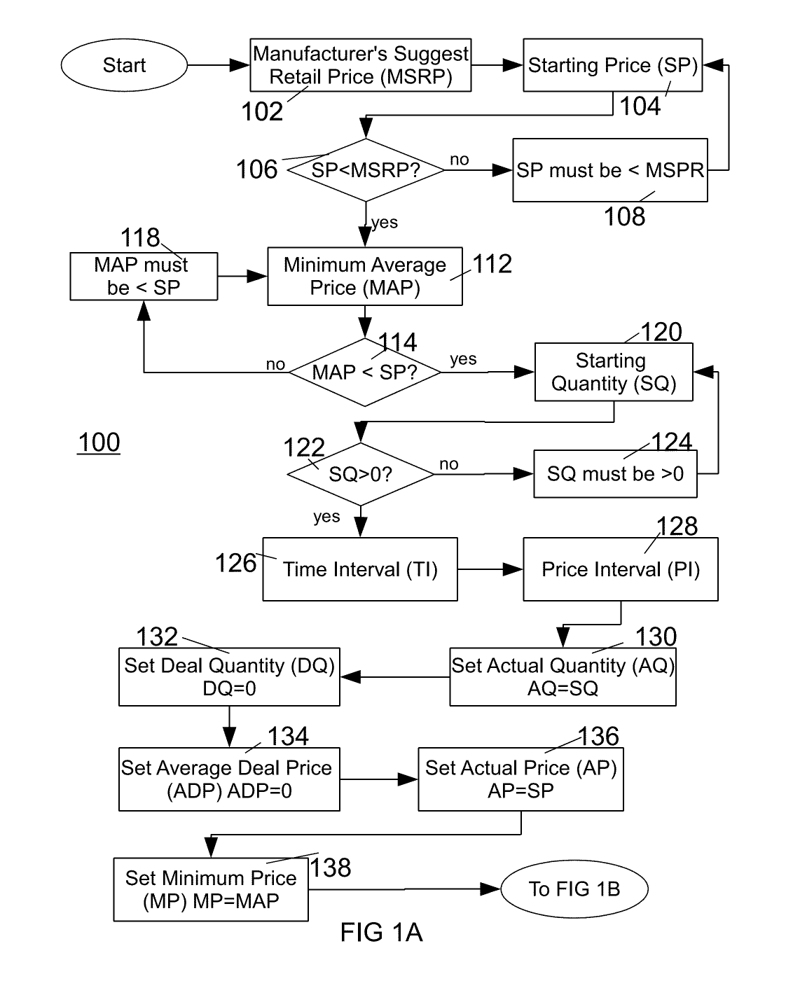

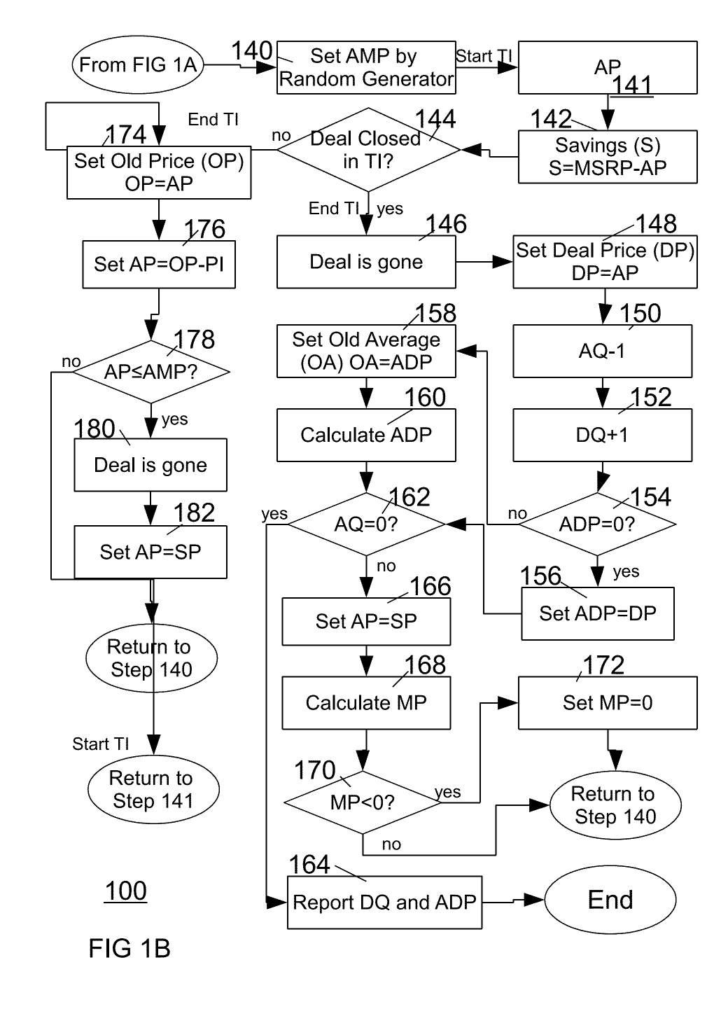

The combination of FIGS. 1A and 1B show an embodiment of a method 100 providing a system that automatically sets the price of an item. FIG. 1A shows steps 102-138 of method 100. In step 102, the manufacturer's suggested retail price is entered. The manufacturer's suggested retail price (MSRP) is the price at which the manufacturer recommends retailer's sell a product. In an embodiment, the manufacturer's suggested retail price is the maximum price that the seller sets for the item being sold. Alternatively, another price may be used as the maximum price, which may be higher or lower than the manufacturer's suggested retail price. Throughout this specification, the manufacturer's suggested retail price and the maximum price may be substituted one for another to obtain different embodiments. In step 104, the starting price (SP) is chosen. In step 106, a determination is made as to whether the starting price is lower than the manufacturer's suggested retail price. If the starting price is not lower than the manufacturer's suggested retail price, the method returns, via 108 (which is the “no” branch) to step 104, and the method 100 again requests the starting price to be set. If the starting price is lower than the manufacturer's suggested retail price, then the method proceeds directly to step 112 (the “yes” branch). In step 112, the minimum average price is set. The minimum average price (MAP) is a price floor designed to prevent the automatic pricing system from reducing the average price that an item is sold at to some unacceptable level. In one embodiment, the minimum average price is set to prevent an item from being sold at a loss. In step 114, a determination is made as to whether the minimum average price is lower than the starting price. If the minimum average price is higher than the starting price, then the method returns, via box 118 (the “no” branch), to step 112 to reset the minimum average price to a price lower than the starting price.

Returning to step 114, if the minimum average price is lower than the starting price, the method proceeds to step 120. In step 120, the starting quantity (which is the initial quantity of units of a particular item that is for sale) is set. In step 122, a determination is made whether the starting quantity is greater than zero. If the starting quantity is zero or less, then the method returns, via box 124 (the “no” branch) to step 120 to reset the starting quantity to one that makes sense.

Returning to step 122, if it is determined that the starting quantity is greater than zero, the method proceeds to step 126, where a time interval is set. The time interval (TI) is the amount of time that the system waits prior to changing the price as a result of there not being enough sales. Next, in step 128, the price interval is set. The price interval (PI) is the amount that the price is incremented or decremented. In an embodiment, the amount that the price is incremented or decremented depends on the number of sales made during the time interval (the time interval was set in step 126). Next in step 130, the actual quantity (AQ), which is the current quantity of items that remain for sale, is set to the starting quantity (because before any items have sold the starting quantity is the number of items for sale). Then, in step 132, the deal quantity (DQ), which is the number of items sold, is set to 0 (because nothing has been sold yet). In step 134, the average deal price is set to zero, as an initial value. The average deal price (ADP) is the average value at which a sale is made (a sale at any price being counted as a deal).

In step 136, the actual price of the items for sale is set to the starting price. The actual price (AP) is the price that the item is currently being advertised and sold at, and is modified with corresponding increments or decrements in the price of the item. Next, in step 138, the minimum price is set to the minimum average price (as the initial value of the minimum price). The minimum price (MP) may be lowered or raised. In an embodiment, the minimum price is set to the lowest price that is high enough to ensure that the price is always high enough to earn a profit, without being a negative number. If some items have been sold for a high price, the minimum price may lowered, and if some items were sold for a low price, the minimum price may be increased. The remainder of the steps of method 100 are in FIG. 1B.

FIG. 1B shows steps 140-182 of method 100. In step 140, the actual minimum price (AMP) is set to a random value between the starting price and the minimum price. The use of a random number generator causes the actual price of the items being sold to reset to the starting price at a different price point for each instance of the actual minimum price being set. Next, between steps 140 and 141, the time interval starts. In step 141, the actual price is displayed to the customer, and the item is offered for sale at the actual price. In step 142, the difference between the manufacturer's price and the actual price is computed, and the difference is displaced as the savings to the customer. In an embodiment, the actual price is not allowed to be higher than the manufacturer's recommended sales price, so that the item is always sold at a discount. In an embodiment, if the actual price is equal to or higher than the manufacturer's recommended sales price, no discount is advertised.

In step 144, a determination is made as to whether a deal has been made and/or the time interval has ended. In an embodiment, step 144 may be triggered by the purchase of an item or the time interval ending, whichever occurs first. If the item was sold within the time interval, the method proceeds, via box 146 (the “yes” branch), because the deal is gone and the item is sold. In step 148, the deal price is set to the actual price. In an embodiment, the deal price is recorded as the price at which an item sold. In step 150, the actual quantity is decremented by 1 to update the number of items remaining in stock. In step 152, the deal quantity is incremented by 1, to update the number of items sold. In step 154, a determination is made whether the average deal price is zero. If the average deal price is zero, then the item sold was the first item sold. If it is determined by the host system that the average deal price is zero, then the method proceeds to step 156. In step 156, the average deal price is set to the current deal price, which is the price that the last item was just sold at, because the last item sold was the first item sold.

Returning to step 154, if it is determined that the average deal price is not zero, then the method proceeds to step 158, where the old average deal price (OA) is set to the value currently stored as the average deal price. Then in step 160, the average deal price is computed. After computing the average deal price, via step 156 or 160, the method proceeds to step 162. In step 162, a determination is made as to whether the actual quantity is equal to zero. I If the actual quantity is equal to zero, then there are no more of this item in stock. If it is determined that the actual quantity is equal to zero, the method proceeds to step 164, where a report is prepared. In an embodiment, the report will indicate various details of the sales, such as the customer's profits. In an embodiment, the report may include the deal quantity (which is the number of items sold) and the average deal price (which is the average price at which the times were sold). After generating a report, the method terminates.

Returning to step 162, if the actual quantity is not zero, the method proceeds to step 166, where the actual price is reset to the starting price before for offering the next copy of the item for sale. In step 168, the minimum price recalculated. In step 170, a determination is made as to whether the minimum price is less than or equal to zero. If in step 170, it is determined that the minimum price is not greater than zero then the method proceeds to step 172, where the minimum price is set to the lowest acceptable value. In an embodiment, the minimum price determination may check if the minimum price is equal to zero. In an embodiment the lowest acceptable value of the minimum price may be zero. In an embodiment the minimum price may be set to a value that is greater than zero. The method then returns to step 140, to offer the next copy of the item for sale.

Returning to step 144, if the time interval ended and no item was sold, then the method proceeds to step 174 (following the “no” branch). In step 174, the old price (OP) is set to the current value of the actual price. Then, in step 176, the actual price is decreased by the amount of the price interval, which in one embodiment may be performed by subtracting the price interval from the old price, then setting the resulting value as the actual price. In step 178, a determination as to whether the actual price is lower than the actual minimum price. If the actual price is greater than the actual minimum price, then the method returns to step 140 (via the “no” branch”) to offer the item for sale at the new price. If the actual price is lower than the actual minimum price then the method proceeds, via box 180 (the “yes” branch), to step 182. In step 182, the actual price is reset to the starting price. Then the method returns to step 140 where the actual minimum price is generated anew and the item is offered for sale again.

Returning to step 178, if the minimum price is greater than the actual minimum price, the time interval is restarted, and the method returns to step 140, where the item is offered for sale at the new reduced price. In other words, the price is decremented each time the price time interval passes without a purchase occurring. If a purchase occurs during a time interval, the price is reset to the original starting price. The price is not allowed to fall below the actual minimum price, and the actual minimum price is randomly chosen, but not allowed to fall below the minimum price. In an embodiment, the minimum price is chosen and recalculated after each item is sold, to be a value that ensures that the average price does not fall below the minimum average price, so as to ensure that the items are sold at a profit.

In an embodiment, each of the steps of method 100 is a distinct step. In another embodiment, although depicted as distinct steps in FIG. 1, steps 100-178 may not be distinct steps. In other embodiments, method 100 may not have all of the above steps and/or may have other steps in addition to or instead of those listed above. The steps of method 100 may be performed in another order. Subsets of the steps listed above as part of method 100 may be used to form their own method.

In an embodiment, the minimum price is allowed to be negative, and some customers may be paid to accept the item as promotional offer in the hope that those customers may return and buy the product at a profitable price. In an embodiment, the minimum average price may be adjusted and/or may be originally set to allow the item to be sold at a loss, in order to minimize the losses. For example, there may be storage costs associated with the items being sold and the longer the items are stored, the greater the expense to the seller. Consequently, to minimize losses, some sellers may adjust the minimum average price to a value that results in a loss, but minimizes the total loss to the seller. In an embodiment, step 144, which checks whether a deal has been made within the time interval, is only performed after a full price interval at which time it is determined whether one or more items were sold during that price interval. If more than one item is sold, the computations for updating the actual quantity and the deal quantity are decremented and incremented, respectively, by that number (instead of being incremented and decremented by just one). In an embodiment, steps 154 and 156 are removed, and the method may proceed from step 152 directly to step 158. In step 160, even after the first item is sold, the average may be calculated by dividing the total of all of the deal prices by the deal quantity. When the first item is sold, the deal quantity is 1, and the total of the deal prices is just the current deal price. In an embodiment, the method tracks the old deal price (ODP), the old average deal price (OAP), and old deal quantity (ODQ). In an embodiment, the average may be calculated from these variables using the following formulas.

T_{odp}=(OA)*(ODQ)

T_{dp}=(T_{odp})+(DP)

ADP=(T_{dp})/(DQ)

Where T_{odp} is the total money value of all previous deals, OA is the old average price of all previous deals, ODQ is the quantity of items sold prior to the most recent sale, T_{dp} is the total money value reflecting the most recent sale, DP is the price at which the most recent item sold, DQ is the quantity of items sold reflecting the most recent sale, and ADP is the average deal price reflecting the most recent sale. Alternatively, this value may be calculated using the following formula:

ADP=[(OA*ODQ)+DP]/(DQ)

In an embodiment, after calculating the minimum price in step 168, instead of performing steps 170 and 172, the minimum price may be adjusted according to the function MP=MAX(MP, 0), which is fully equivalent to steps 170 and 172. The MAX function takes the inputs and outputs the highest value. Here the two choices are the minimum price and zero, and whichever value is higher will be selected by the MAX function.

In an embodiment, at any time, such as between steps 102 and 138, or at any other time, an administrative user may change prior choices for any value already chosen. In an embodiment, steps 126 and 28 (choosing the time interval and price interval) may be set any time between steps 102 and 138 and in any order with respect to one another.

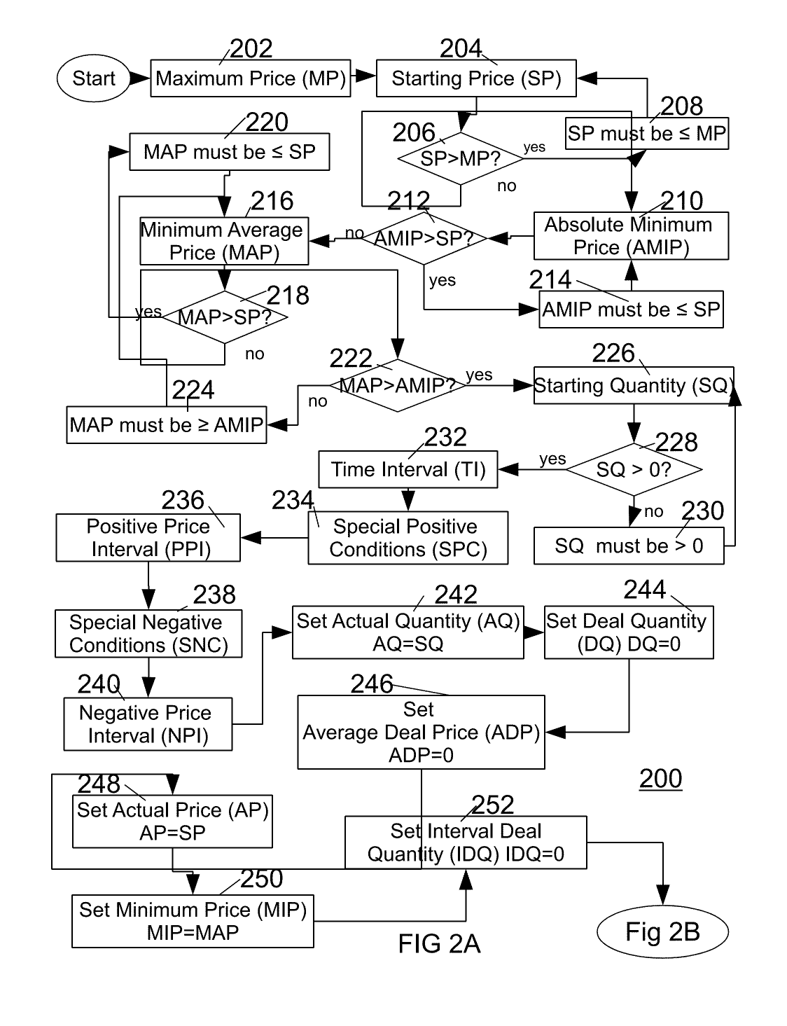

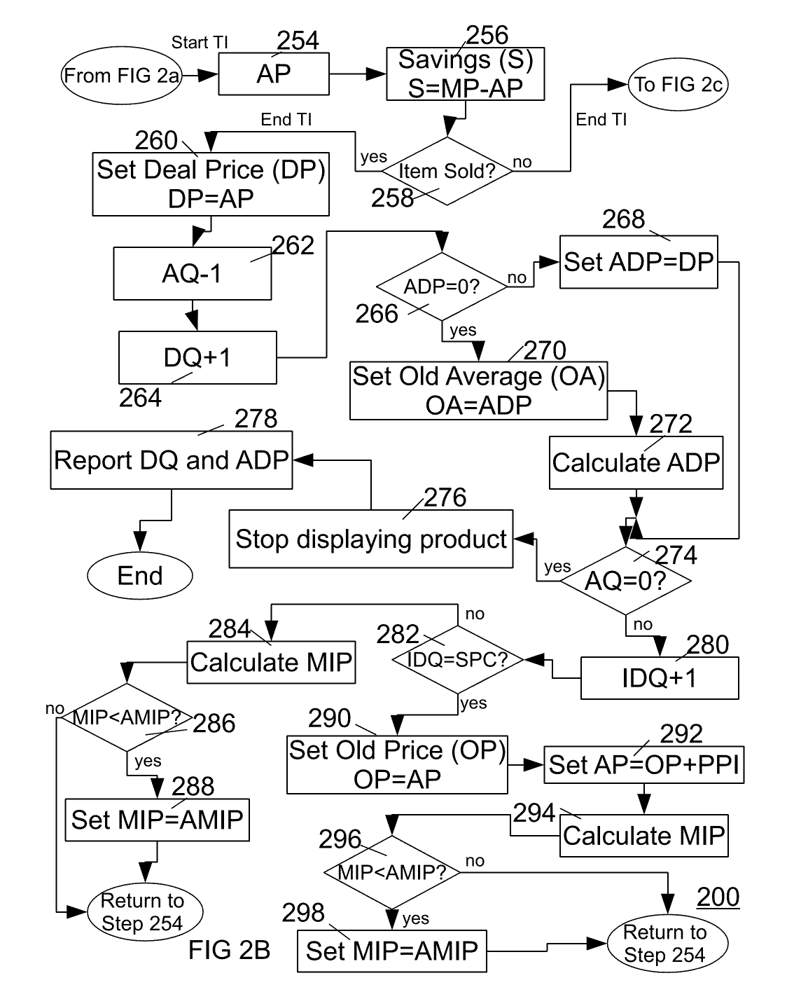

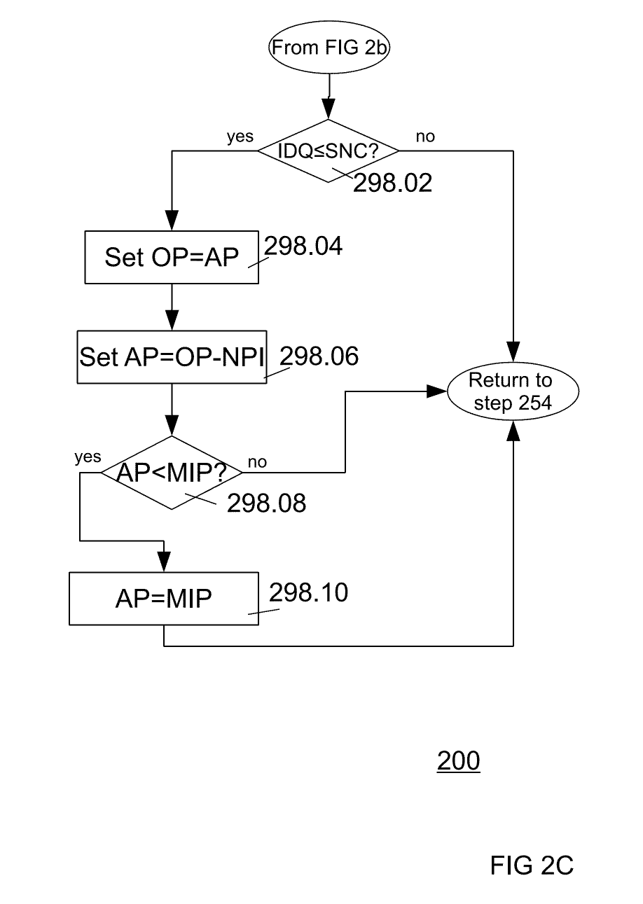

FIGS. 2A, 2B, and 2C shows an embodiment of a method 200 for automatically setting the price of an item. FIG. 2A shows steps 202-252 of method 200. In step 202, the maximum price (MXP) is set, which may be the manufacturer's suggested retail price. In step 204, the starting price is chosen, which is the initial price offering for at an item. In step 206, a determination is made as to whether the starting price is higher than the maximum price. If the starting price is higher than the maximum price the method returns, via 208 (which is the “yes” branch) to step 204, and the method 200 again requests the starting price to be set. If the starting price is not higher than the maximum price, the method proceeds to step 210 (the “no” branch). In step 210, the absolute minimum price is set. The absolute minimum price (AMIP) is a price floor below which the minimum price, which is recalculated and changed during the course of the method, from falling below a minimum value. In step 212, a check is made as to whether the absolute minimum price is lower than the starting price. If the absolute minimum price is not lower than the starting price, then method 200 returns, via step 214 to step 210 to reset the absolute minimum price. Since the absolute minimum price must be less than the starting price and since the starting price must be less than the maximum price, the absolute minimum price will be less than the maximum price.

Returning to step 214, if it is determined that the absolute minimum price is lower than the starting price, the method proceeds to step 216. In step 216, the minimum average price is set, which is the minimum value for the average price. In step 218, a determination is made as to whether the minimum average price is lower than the starting price, if the minimum average price is higher than the starting price, then the method returns, via box 220 (the “yes” branch), to step 216 to reset the minimum average price. Returning to step 218, if the minimum average price is lower than the starting price, the method proceeds to step 222. In step 222, a determination is made as to whether the minimum average price is lower than the absolute minimum price. If the minimum average price is not higher than the absolute minimum price, then the minimum average price is too low, and causes the method to return, via 224 (the “no” branch), to step 216.

Returning to step 222, if a determination is made that the minimum average price is higher than the absolute minimum price, then the choice for the minimum average price is valid, and the method proceeds to step 226. In step 226, the starting quantity (which is the initial quantity of units of a particular item that are available for sale) is entered. In step 228, a determination is made whether the starting quantity is greater than zero. If the starting quantity is zero or less the method returns, via box 230 (the “no” branch) to step 226 to set the starting quantity to a value greater than zero. Returning to step 228, if it is determined that the starting quantity is greater than zero, the method proceeds to step 232, where a time interval is set. In an embodiment, the time interval is the amount of time that the system waits prior to changing the price of an item as a result of the number of sales made during the time interval. In an embodiment, there may be a check to ensure that the choice of the time interval is a value greater than zero, greater than the minimum amount of time required to complete a sale, or greater than another value.

Next in step 234, positive sale conditions are set. The positive sale conditions (PSC) are conditions, which if met indicate that the demand for the product is increasing and/or at a high enough level to warrant increasing the price of the item. In an embodiment, there is a threshold for the number of items sold during a given time interval or for the time interval between the sale of the last item to the sale of the current item, which if crossed, indicates that an increase in price may be beneficial to the seller. Next, in step 236, the positive price interval (PPI) is chosen, which is the amount that the price is incremented if the positive sale conditions are met.

Next in step 238 negative sale conditions are set. The negative sale conditions (NSC) are conditions, which if met indicate that the demand for the product is decreasing and/or are at a low enough level to warrant decreasing the price of the item, so more will sell or so that the item will sell at a quicker rate. In an embodiment, there is a threshold for the number of items sold during a given time interval or for the time interval between the sale of the last item to the sale of the current item, which if crossed, indicates that a decrease in price may be beneficial to the seller. Next, in step 240, the negative price interval (NPI) is chosen, which is the amount that the price is decremented if the negative sale conditions are met.

Next in step 242, the actual quantity, which is the current quantity of items that remain for sale, is set to the starting quantity. Then, in step 244, the deal quantity, which is the number of items sold, is set to 0. In step 246, the average deal price is set to zero as the initial value of the average deal price. In step 248, the actual deal price is set to the starting price as the initial value, because the first item to be sold will be sold at the starting price.

Next, in step 250, the minimum price is set to the minimum average price. As explained in conjunction with method 100, in an embodiment, the minimum price may be lowered or raised in order to ensure that the price may be as low as possible while still being high enough to ensure a profit. If some items have been sold for a high price, the minimum price may lowered, and if some items were sold for a low price, the minimum price may be increased. In step 252, the interval deal quantity (IDQ) is set to zero, which is the time since the start of the time interval until the deal is made or an item is sold. In an embodiment, as in method 100, an actual minimum price may be set to a random value between the starting price and the minimum price. The remainder of the steps of method 200 appear in FIGS. 2B and 2C.

FIG. 2B shows steps 254-298 of method 200. Next, after step 252 of FIG. 2A, the time interval starts, and in step 254, the actual price is displayed to the customer, and the item is offered for sale at the actual price. In step 256, the difference between the maximum price (which may be the manufacturer's suggested retail price) and the actual price is computed, and the difference is displayed as the savings to the customer. In an embodiment, the actual price is not allowed to be higher than the maximum price, so that the item is always sold at a discount, or if the actual price is equal to the maximum price, no discount is advertised. In step 258, a determination is made as to whether a deal was made. In an embodiment, step 258 may be triggered by the purchase of an item. If the item was sold, the method proceeds to step 260 (the “yes” branch). In step 260, the deal price is set to the actual price. In an embodiment the deal price is recorded as the price at which this item sold. In step 262, the actual quantity is decremented by 1, thereby representing the number of items remaining in stock. In step 264, the deal quantity is incremented by 1, thereby representing the number of items sold. In step 266, a determination is made whether the average deal price is zero, which is an indication as to whether the item sold was the first item sold. If the host system determines that the average deal price is zero, then the method proceeds to step 268. In step 268, the average deal price is set to the current deal price, which is the price that the last item was just sold at, because, as determined by step 266, the last item sold was the first item sold.

Returning to step 266, if it is determined that the average deal price is not zero, then the method proceeds to step 270, where the old average deal price is set to the value currently stored as the average deal price. Then, in step 272, the average deal price is computed. After computing the average deal price, via step 268 or 272, the method proceeds from step 270 or 272, respectively, to step 274. In step 274, a determination is made as to whether the actual quantity is equal to zero, which if equal to zero indicates that there are no more of this item in stock. In an embodiment, if it is determined that the actual quantity is equal to zero, the method proceeds to step 276, and the item is removed from sale, which may entail removing the item from the website and/or displaying an indication that the item is sold out. In step 278, a report is prepared, indicating various details of the sales, such as the seller's profits. In an embodiment, the report may include the deal quantity (which is the number of items sold) and the average deal price (which is the average price at which the times were sold). In an embodiment, after the report is generated, the method terminates.

Returning to step 274, if the actual quantity is not zero, the method proceeds to step 280, where the interval deal quantity is incremented by one. The interval deal quantity is the number of deals that were completed during the time interval. In step 282, a determination is made as to whether the positive sale condition is met. In an embodiment, the special deal condition is a threshold value, and a comparison may be performed to determine whether the interval deal quantity is equal to or greater than that threshold value. If the positive sale condition is not met, then the method proceeds to step 284 (following the “no” branch).

In step 284, the minimum price is recomputed taking into account the most recent sale, which may lower or raise the minimum price, depending on whether the deal price is higher or lower than the minimum average price and the current average price. In an embodiment, if the deal price is lower than the minimum average price or the current average price, the minimum price is likely to be increased to avoid an overall loss. If the deal price is higher than the minimum average price and the current average price, the minimum price is likely to be decreased. In step 286, a determination is made as to whether the minimum price is lower than the absolute minimum price. If it is determined that the minimum price is greater than the absolute minimum price, the new minimum price is acceptable, and the method returns directly to step 254. In step 254, the product is again offered for sale at the actual price, which has not been changed, because the positive sale conditions were not met. In an embodiment, the time interval is not restarted at this point unless the time interval expired. Similarly, the interval deal quantity is not reset at this point.

Returning to step 286, if the host system determines that the minimum price is lower than the absolute minimum price, the new minimum price is not acceptable, and the method proceeds to step 288. In step 288, the minimum price is set to the absolute minimum price. After step 288, the method returns to step 254, with the actual price unchanged, because the positive sale conditions were not met. In an embodiment, the time interval is not restarted at this point unless the time interval expired. In an embodiment, just prior to returning to step 254, whether returning after step 286 or 288, or any time after step 258 along the “yes” branch, there may be a check performed to determine whether the time interval expired. Similarly, the interval deal quantity is not reset at this point.

Returning to step 282, if the positive sale conditions are met, for example, if the interval deal quantity is equal to or greater than a threshold value, the method proceeds to step 290 (following the “yes” branch). In step 290, the old price is set to the actual price. In step 292, the actual price is increased. In an embodiment, the actual price is incremented by the positive price interval (in other embodiments another formula may be implements for incrementing the price, such as one based on expected diminishing returns).

In step 294, the minimum price is recomputed taking into account the most recent sale, which may lower or raise the minimum price, depending on whether the deal price is higher or lower than the minimum average price and the current average price. In step 296, a determination is made as to whether the mini price is lower than the absolute minimum price. If it is determined that the minimum price is greater than the absolute minimum price, the new minimum price is acceptable, and the method returns directly to step 254. In step 254, the product is again offered for sale at the actual price, which has been incremented, because the positive sale conditions were met. In an embodiment, the time interval is restarted at this point.

Returning to step 296, if it is determined that the minimum price is lower than the absolute minimum price the new minimum price is not acceptable, and the method proceeds to step 298. In step 298, the minimum price is set to the absolute minimum price. After step 298, the method returns to step 254, with the actual price increased, because the positive sale conditions were met. In an embodiment, the time interval is restarted at this point.

Returning to step 258, if the time interval ended and no item was sold, then the method proceeds to step 298.02 (following the “no” branch). The remainder of the steps of method 200 appear in FIGS. 2C.

FIG. 2C shows steps 298.02-298.10 of method 200. In step 298.02, a determination is made as to whether the negative sale conditions are met. If the negative sale conditions are not met the method returns to step 252 (FIG. 2A) where the interval deal time is set to 0, restarting the interval time deal and again offering the item for sale.

Returning to step 298.02, if the negative sale conditions are met the method proceeds to step 298.04. In step 298.04, the old price is set to the current value of the actual price. Then, in step 298.06, the actual price is decreased by the amount of the negative price interval, which in one embodiment may be performed by subtracting the negative price interval from the old price. In step 298.08, a determination is made as to whether the actual price is lower than the minimum price. If the actual price is lower than the minimum price, then the price is set to the minimum price, then the method proceeds, via box 298.10 (following the “no” branch), to step 252 (FIG. 2A). In step 252, the interval deal time is reset and the item is offered for sale at the new price, which is the minimum price.

Returning to step 298.08, if the actual price is greater than the minimum price, the time interval is restarted, and the method returns to step 252 (FIG. 2A), where the item is offered for sale at the new reduced price. In other words, the price is decremented each time the price time interval passes and the negative sale conditions are satisfied, but is not decremented if the time interval passed without the negative sale condition being satisfied.

In the method 200 in FIGS. 2A, 2B, and 2C, the price is incremented each time a deal is made and the positive sale conditions are satisfied, but is not incremented if the deal was made without the positive sale condition being satisfied. The price is not allowed to fall below the minimum price, which in turn cannot be below the absolute minimum price. The minimum price is chosen and recalculated after each item is sold to be a value that ensures that the average price does not fall below the minimum average price, so as to ensure that the items are sold at a desired profit (or in another embodiment the items are at least not sold below an acceptable loss).

In an embodiment, each of the steps of method 200 is a distinct step. In another embodiment, although depicted as distinct steps in FIGS. 2A, 2B, and 2C, steps 200-298.10 may not be distinct steps. In other embodiments, method 200 may not have all of the above steps and/or may have other steps in addition to or instead of those listed above. The steps of method 200 may be performed in another order. Subsets of the steps listed above as part of method 200 may be used to form their own method.

In one embodiment, the positive sale condition is an estimate performed to project whether the increased price results in an increase in profits despite the projected decrease in the rate of items being sold at the higher price. Although the specification discusses an item being sold, in an embodiment any deal having a price with a limited number of available slots or deals may be substituted. In general, when a value V, needs to be greater than or equal to a minimum, after making an initial computation of the value the, value may be adjusted by the function V=MAX(V,MinV), where MinV is a given minimum value. Similarly, when a value V, needs to be less than or equal to than a maximum, after making an initial computation of the value the value may be adjusted by the MINfunction V=MIN(V,MaxV), where MaxV is a given maximum value, and the MIN function takes any number of inputs and outputs the variable with the highest value.

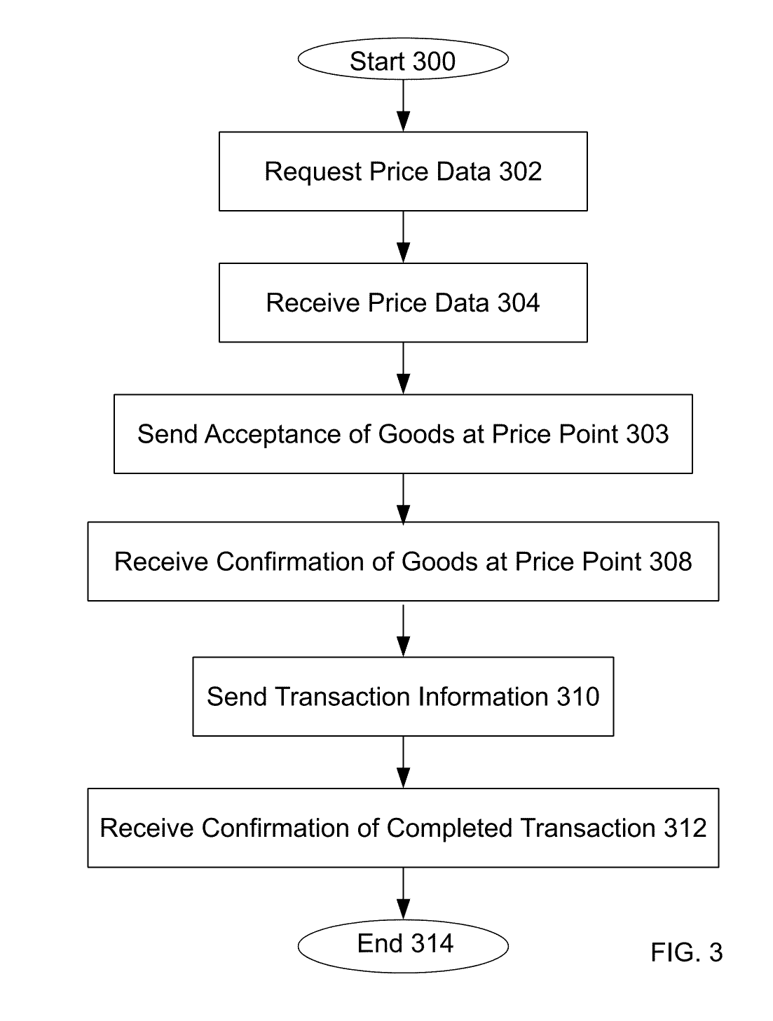

FIG. 3 is a flow diagram illustrating the client user process of buying an item from the method for an automated pricing system shown in FIGS. 1 and 2. The process begins at Start 300. At request price data 302, the client sends a request for the price of an item being sold using the automated pricing system. At receive price data 304, the client receives the price data for the specified item. If the client finds the price acceptable, at send acceptance of goods at price point 306, the client sends an acceptance of the offer to sell the item at the specified price point. At receive confirmation of goods at price point 308 the client receives a confirmation of the sale at a given price from the system using the automated pricing system. At send transaction information 310, the client then sends the necessary information to complete the transaction. In one embodiment, this transaction is done online using a credit card. In one embodiment, this transaction information is entered into a website connected to a server system using the automated pricing system. At receive confirmation of completed transaction 312, the client receives a confirmation that the sale has been completed. In an embodiment the host system sends an email to the client which includes a receipt of the transaction. In an embodiment, the client is sent a webpage outlining the details of the transaction and the delivery or pickup information. At end 314 the process terminates.

In an embodiment, although depicted as distinct steps in FIG. 3, steps 300-314 may not be distinct steps. In other embodiments, not all of the above steps may be included and/or other steps may be performed in addition to, or instead of, those listed above. In an embodiment, the steps may be performed in another order.

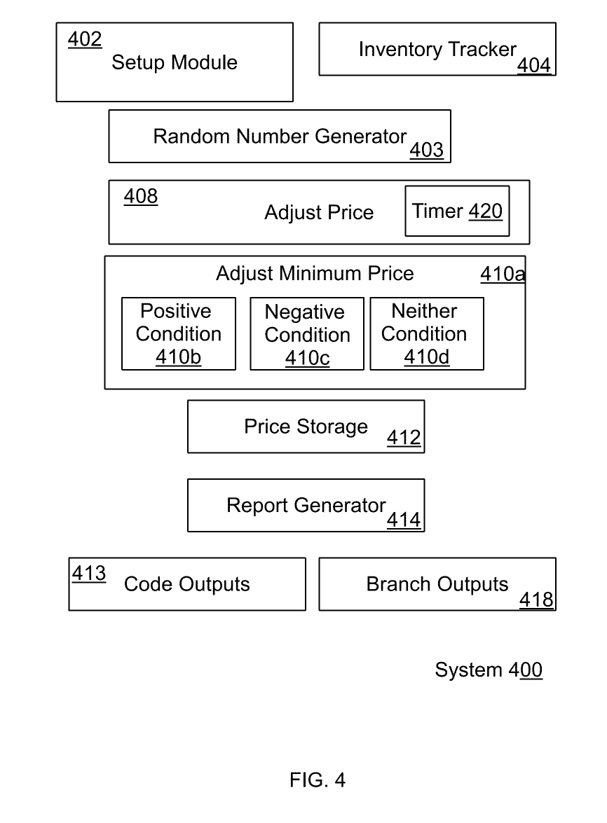

FIG. 4 illustrates a block diagram of an embodiment of a system 400 that uses the method for an automated pricing system shown in FIGS. 1A through 2C. System 400 may include setup module 402, random number generator 403, inventory tracker 404, adjust price 408, timer 409, adjust minimum price 410a, positive condition 410b, negative condition 410c, neither condition 410d, price storage 412, report generator 414, code outputs 413, and branch outputs 418. Other embodiments of system 400 may include all of the components listed and/or may include other components.

In one embodiment, system 400 implements a system for automating prices. Setup module 402 includes all the input parameters needed to fully automate the pricing system. In an embodiment, the parameters of setup module 402 can be entered using input systems or input/output system. Starting price 104 is an example of an input parameter from FIG. 1A, because it is a parameter chosen by the user and entered into the method for automating prices. In an embodiment, all of the steps 102 to 142 and 202 to 252 before the time interval of timer 409 in FIGS. 1A through 2C activates are processed by setup module 402. Random number generator 403 generates a random number between two specified boundaries. In an embodiment, step 140 in FIG. 1B uses random number generator 406 to generate a random number, which becomes the actual minimum price, between the starting price and the minimum price entered by the user. Inventory tracker 404 includes the quantities of all items for sale. In an embodiment, the quantity of goods remaining can be displayed on an output system, handheld system, or client system. Adjust price 408 adjusts the price when no sale occurs during the time interval, or when certain conditions are met when sales do occur during the time interval. Adjust price 408 may also calculate other the variables related to adjusting the price. For example, in step 168 in FIG. 1B, it is necessary to calculate a new minimum price, which is handled by adjust price 408. Adjust price 408 may also include timer 409. Timer 409 is a time counter which can be set to any amount of time. Timer 409 starts a cycle of the method as shown in FIGS. 1 and 2. When the time interval of timer 409 runs down an action is triggered. In different embodiments, this action is triggered by whether an item is sold, whether an item is not sold, or the quantity of items sold during the time counter running in timer 409. Adjust price 408 may also contain adjust minimum price 410a, which computes the minimum price whenever necessary. In an embodiment, adjust minimum price 410a may compute the minimum price after each sale to determine whether the minimum price needs to be raised to avoid more than an unacceptable loss or can be lowered without danger of incurring an unacceptable loss. Adjust price 408 can also raise or lower the sale price of an item according to certain negative and positive conditions. For example, if the positive condition is satisfied, then adjust price 410a sends the method down the “yes” branch at step 282 to step 290, which results in the actual price of an item being increased. If the condition is not satisfied, then adjust minimum price 410a sends the method down the “no” branch to step 284. Positive condition 410b is the section of code from step 290 to step 298 that adjusts the price if the positive is incurred. Negative condition 410c is the section of code from step 298.02 to step 298.10 that adjusts the price if the negative is incurred. Neither condition 410d is the section of code, which occurs at the no branches of steps 284-288 and 298.02 that adjusts the price if neither the negative or positive condition is incurred.

In the embodiments of FIG. 2A-2C, no price change occurs if the negative condition and positive condition occurs. Positive condition 410b, negative condition 410c, and neither condition 410d are optional. The embodiment of FIGS. 1A and 1B does not have positive condition 410b, negative condition 410c, and neither condition 410d, whereas the embodiment of FIG. 2 has positive condition 410b, negative condition 410c, and neither condition 410d.

Price storage 412 includes all of the prices used in the method for automating prices, both the ones that are input, included in setup module 402, and the ones that are calculated using adjust price 408. Report generator 414 tracks the quantities that are used to generate a report when an item has sold out. In an embodiment, report generator 414 includes various details of the sales, such as the seller's profits. In an embodiment, the report may include the deal quantity (which is the number of items sold) and the average deal price (which is the average price at which the times were sold). Code outputs 413 includes all of the outputs of the adjust price 408, adjust minimum price 410a, random number generator 403 and setup module 402. These outputs are calculated and stored in steps 148-170, 174-182, 260-274, 280, 290-294, and 289.04-298.10. In an embodiment, code outputs 413 is stored using volatile memory, because the values in code outputs 413 are rewritten when a new calculation occurs and the old values are moved to another memory storage. For example, once the step 168 in FIG. 1B calculates the minimum price, the value for the minimum price can be stored in price storage 412 and can be deleted from code outputs 416. Branch outputs 418 includes the results of the minimum price 410a. In an embodiment, minimum price 410a is stored in volatile memory and can be rewritten once the method for automating prices has cleared a branch of the method. In an embodiment, branch outputs 418 is a log which keeps track of the timeline for each item sale and is included in report generator 414.

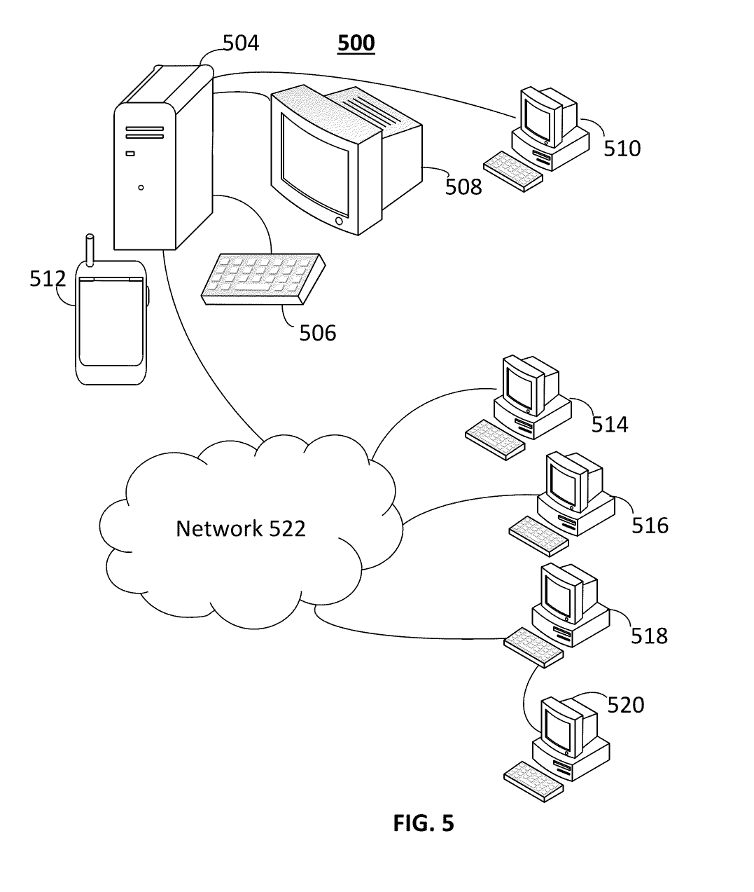

FIG. 5 illustrates a block diagram of an embodiment of a network 500 for implementing the methods of FIGS. 1 and 2 for automatically adjusting prices on a website for selling items. The system 500 includes a server system 504, an input system 506, an output system 508, a plurality of client systems 510, 514, 516, 518 and 520, a communications network 512 and a hand-held device 522. In other embodiments, the system 500 may include additional components and/or may not include all of the components listed above.

Server system 504 may include one or more servers. Server system 504 may be the property of the seller of the items or another entity that maintains a server that the seller of the items has use of.

Input system 506 system may be used for entering input into server system 504, and may include any one of, some of, any combination of, or all of a keyboard system, a mouse system, a track ball system, a track pad system, buttons on a handheld system, a scanner system, a wireless receiver, a microphone system, a connection to a sound system, and/or a connection and/or an interface system to a computer system, intranet, and/or the Internet (e.g., IrDA, USB), for example. In an embodiment, the seller may interact with server system 504 to input the initial parameters of the methods of FIGS. 1 and 2.

Output system 508 may be used for receiving output from server system 504, and may include any one of, some of, any combination of or all of a monitor system, a wireless transmitter, a handheld display system, a printer system, a speaker system, a connection or interface system to a sound system, an interface system to peripheral devices and/or a connection and/or an interface system to a computer system, intranet, and/or the Internet, for example. In an embodiment, output system 508 may provide reports to the seller about sales that occur via a website, which may be generated by the methods of FIGS. 1 and 2.

The system 500 illustrates some of the variations of the manners of connecting to the server system 504, which may be displayed on an information providing site (not shown). Server system 504 may be directly connected and/or wirelessly connected to the plurality of client systems 510, 514, 516, 518 and 520 and/or server system 504 may be connected via the communications network 512 to the plurality of client systems 510, 514, 516, 518 and 520. Any of client systems 510, 514, 516, 518, and 520 may belong to or be operated by customers of the seller for purchasing goods sold by the methods of FIGS. 1 and 2. Similarly, the seller may interact, via any of client systems 510, 514, 516, 518, and 520 with server 504 to maintain a website for selling goods, receive reports generated by the methods of FIGS. 1 and 2, and/or set parameters of the methods of FIGS. 1 and 2, for example.

Client system 520 may be connected to server system 504, via client system 518. The communications network 512 may be any one of, or any combination of, one or more Local Area Networks (LANs), Wide Area Networks (WANs), wireless networks, telephone networks, the Internet and/or other networks. The communications network 512 may include one or more wireless portals. The client systems 510, 514, 516, 518, and 520 are any system that an end user may use to access the server system 504. For example, the client systems 510, 514, 516, 518 and 520 may be personal computers, workstations, laptop computers, game consoles, handheld network enabled audio/video players and/or any other network appliance. The client system 520 accesses the server system 504 via the combination of the communications network 512 and another system, which in this example is client system 518 The client system 522 is an example of a handheld wireless device, such as a mobile phone or a handheld network enabled audio/music player, which may also be used for accessing network content. In another embodiment, any combinations of client systems 510, 514, 516, 518, 520 and/or 522 may include a GPS system.

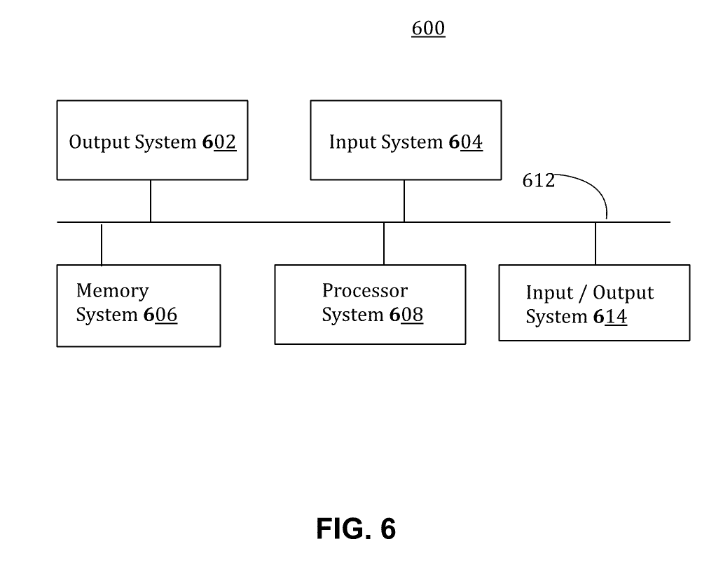

FIG. 6 shows a block diagram of a computer 600 used in FIGS. 1-3. The computer 600 may include output system 602, input system 604, memory system 606, processor system 608, communications system 612, and input/output device 616. In other embodiment, computer 600 may include additional components and/or may not include all of the components listed above. Computer 600 is an example of a computer that may be used for the computer of FIGS. 1-3. Computer 600 may be a server for hosting webpages for selling products. The architecture of computer 600 may be used for any of server system 504 or the plurality of client systems 510, 514, 516, 518 and 520. Output system 602 may include any one of, some of, any combination of, or all of a monitor system, a handheld display system, a printer system, a speaker system, a connection or interface system to a sound system, an interface system to peripheral devices and/or a connection and/or interface system to a computer system, intranet, and/or internet, for example.

Input system 604 may include any one of, some of, any combination of, or all of a keyboard system, a mouse system, a track ball system, a track pad system, buttons on a handheld system, a scanner system, a microphone system, a connection to a sound system, and/or a connection and/or interface system to a computer system, intranet, and/or internet (e.g., IrDA, USB), for example.

Memory system 606 may include, for example, any one of, some of, any combination of, or all of a long term storage system, such as a hard drive; a short term storage system, such as random access memory; a removable storage system, such as a floppy drive or a removable drive; and/or flash memory. Memory system 606 may include one or more machine-readable mediums that may store a variety of different types of information. The term machine-readable medium is used to refer to any non-transient medium capable carrying information that is readable by a machine. One example of a machine-readable medium is a non-transient computer-readable medium. Another example of a machine-readable medium is paper having holes that are detected that trigger different mechanical, electrical, and/or logic responses. In the case in which sever 504 is computer 600, memory system 606 may store one or more computer instructions for implementing the methods of FIGS. 1 and 2, and for a website for selling products.

Processor system 608 may include any one of, some of, any combination of, or all of multiple parallel processors, a single processor, a system of processors having one or more central processors and/or one or more specialized processors dedicated to specific tasks. Processor 608 implements the computer instructions stored in memory system 606. In the case in which sever 504 is computer 600, processor system 608 may implement computer instructions for implementing the methods of FIGS. 1 and 2, and for a website for selling products.

Communications system 612 communicatively links output system 602, input system 604, memory system 606, processor system 608, and/or input/output system 616 to each other. Communications system 612 may include any one of, some of, any combination of, or all of electrical cables, fiber optic cables, and/or means of sending signals through air or water (e.g. wireless communications), or the like. Some examples of means of sending signals through air and/or water include systems for transmitting electromagnetic waves such as infrared and/or radio waves and/or systems for sending sound waves.

Input/output system 616 may include devices that have the dual function as input and output devices. For example, input/output system 616 may include one or more touch sensitive screens, which display an image and therefore are an output device and accept input when the screens are pressed by a finger or stylus. The touch sensitive screens may be sensitive to heat and/or pressure. One or more of the input/output devices may be sensitive to a voltage or current produced by a stylus, for example. Input/output system 616 is optional, and may be used in addition to or in place of output system 602 and/or input device 604. Each embodiment disclosed herein may be used or otherwise combined with any of the other embodiments disclosed. Any element of any embodiment may be used in any embodiment.

network 500 Network 500 network 500 network 500 Each embodiment disclosed herein may be used or otherwise combined with any of the other embodiments disclosed. Any element of any embodiment may be used in any embodiment.

Although the invention has been described with reference to specific embodiments, it will be understood by those skilled in the art that various changes may be made and equivalents may be substituted for elements thereof without departing from the true spirit and scope of the invention. In addition, modifications may be made without departing from the essential teachings if the invention.

1. A machine implemented method for automating prices, comprising:
setting, via a machine having at least a processor system having at least one processor and a memory system, an initial pricing point for an item;
setting, via the machine, a time interval;
determining, via the machine, whether the item was purchased during the time interval;
determining, via the machine, whether the price of the item should be modified;
and
sending the price to a client machine as a sales price of the item.

2. The method of claim 1, further comprising
setting a price interval, and
decreasing the price by the price interval if no units of the item is not purchased after a predetermined time interval.

3. The method of claim 2, further comprising setting a price floor, below which the machine can never decrease the sales price of the item.

4. The method of claim 3, further comprising setting an inventory counter, the inventory counter being a value equal to the quantity of an item in stock.

5. The method of claim 4, further comprising calculating, via the processor system, a minimum price, the minimum price being the lowest price an item can be sold for and still generate a profit.

6. The method of claim 5, further comprising calculating, via the processor system, a minimum price which is the lowest price an item can be sold for to minimize losses.

7. The method of claim 6, further comprising calculating, via the processor system, an effective price floor, the effective price floor being a price point below which any current discounts from the starting price will be reset and the current price will be reset to a starting price.

8. The method of claim 7, further comprising determining, via the machine, whether a current price that the item is being offered for sale is below the effective price floor; and
if, as determined by the processor system, the current price is below the effective price floor, resetting the current price of the item to an earlier starting price.

9. The method of claim 8, further comprising sending the savings to a client machine, the savings being the difference between a manufacturer's suggested retail price for an item and the current price for the item.

10. The method of claim 9, further comprising recording, if it is determined via the machine that an item has been sold during the time interval, the deal price at which the item was sold; and
calculating, via the processor system, an average deal price, the average deal price being the average price at which the item has been purchased averaged over all the sales in a given time period.

11. The method of claim 10, further comprising calculating, via the processor system, a new minimum price, based on at least the sales performance of the item for sale.

12. The method of claim 11, further comprising setting an interval deal counter, for each item sold during a given time interval.

13. The method of claim 12, further comprising resetting the interval deal counter at the conclusion of the time interval.

14. The method of claim 13, further comprising setting a positive sale condition, the positive sale condition being an indicator that the demand for a product is increasing, based at least on the number of items sold during a given time interval.

15. The method of claim 14, further comprising
determining, via the machine, whether a positive sale condition has been met, and
if, it is determined by the machine that the positive sale condition has been met, raising, via the machine, the price of the item.

16. The method of claim 15, further comprising setting a positive sale condition, the positive sale condition being an indicator that the demand for a product is decreasing, based at least on the number of items sold during a given time interval.

17. The method of claim 16, further comprising determining, via the machine, whether a negative sale condition has been met, and
if, as determined by the processor system, the negative sale condition has been met, lowering, via the machine, the price of the item.

18. The method of claim 17, further comprising determining, via the machine, whether the item being sold is out of inventory,
if, as determined by the processor system, the item is out of stock, sending a message to a client machine that the item is no longer being sold, and
ceasing to display the product on the client machine.

19. The method of claim 19, further comprising calculating, via the machine, the number of items sold and the average sale price of the items sold, and
sending a report listing the number of items sold and the average sale price of the items to a client machine.

20. A system for automating prices over a computer network, the system comprising:
a processor system and a memory system having at least a machine-readable medium carrying one or more sequences of instruction for a method for automating prices on a host system, which when executed by one or more processors, cause the one or more processors to carry out the method comprising:
setting, via a machine having at least a processor system having at least one processor and a memory system, an initial pricing point for an item;
setting, via the machine, a time interval;
determining, via the machine, whether the item was purchased during the time interval;
determining, via the machine, whether the price of the item should be modified;
and
sending the price to a client machine as a sales price of the item.
